(19) United States
(12) Patent Application Publication
(10) Pub. No.: US 2024/0010265 A1
(43) Pub. Date: Jan. 11, 2024

(54) LASER TEXTURED FRICTION SURFACE FOR INTERFACING COMPONENTS

(71) Applicant: Steering Solutions IP Holding Corporation, Saginaw, MI (US)

(72) Inventors: Paul T. Duvendack, Saginaw, MI (US); Wes Mccullough, Saginaw, MI (US); Alfonso Mejia, Saginaw, MI (US); Mark W. Duthie, Saginaw, MI (US)

(21) Appl. No.: 17/987,437

(22) Filed: Nov. 15, 2022

Related U.S. Application Data
(60) Provisional application No. 63/388,019, filed on Jul. 11, 2022.

(51) Int. Cl. B62D 3/00; B23K 26/352

(52) U.S. Cl. CPC B62D 3/00; B23K 26/355

(57) ABSTRACT

A friction assembly for mounted components includes a first component having a first interface surface. The friction assembly also includes a second component having a second interface surface, wherein the first interface surface and the second interface surface are in contact in an assembled condition. One of the first interface surface and the second interface surface are textured to form a friction surface.

### CROSS-REFERENCE TO RELATED APPLICATION

This application claims the benefits of priority to U.S. patent application Ser. No. 63/388,019, filed Jul. 11, 2022, the disclosure of which is incorporated by reference herein in its entirety.

### FIELD OF THE INVENTION

This disclosure relates to a laser textured friction surface for interfacing components.

### BACKGROUND

A vehicle, such as a car, truck, sport utility vehicle, crossover, mini-van, marine craft, aircraft, all-terrain vehicle, recreational vehicle, or other suitable vehicles, include various steering system schemes, for example, steer-by-wire (SbW) and driver interface steering. Often, the various steering schemes include an electric power steering (EPS) system including components such as steering wheel, column, rack-pinion gear, electric motor actuator etc. The EPS helps the operator to steer a vehicle by providing necessary assist torque and feedback.

Certain rack EPS systems may have an issue with a steering gear moving relative to a frame where the steering gear is mounted since the surface of the mounting bushing is smooth. The extreme loading of some vehicles can overcome the clamp load from some mountings, particularly during off road or extreme maneuvers. This is just one example of an assembly which could slip relative to its mounting surface. The embodiments disclosed herein address this issue.

### SUMMARY

According to one aspect of the disclosure, a friction assembly for mounted components includes a first component having a first interface surface. The friction assembly also includes a second component having a second interface surface, wherein the first interface surface and the second interface surface are in contact in an assembled condition. One of the first interface surface and the second interface surface are textured to form a friction surface.

According to another aspect of the disclosure, a steering system includes a steering gear. The steering system also includes a frame having a frame surface. The steering system further includes a bushing having a bushing surface in operative contact with the frame surface and the steering gear, wherein the bushing surface is textured to form a friction surface.

According to yet another aspect of the disclosure, a method of manufacturing an interfacing component assembly is provided. The method includes comparing a first hardness of a first material of a first component to a second hardness of a second material of a second component. The method also includes determining which of the first material and the second material is a harder material. The method further includes texturing the harder material to form a friction surface with a laser. The method yet further includes placing the first component and the second component together with the friction surface being an interface between the first component and the second component.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 schematically illustrates a steering system having a steering gear;

FIG. 2 is a perspective view of a portion of a steering rack assembly; and

FIG. 3 is a perspective view of a laser textured bushing surface.

### DETAILED DESCRIPTION

The following discussion is directed to various embodiments of the disclosure. The embodiments disclosed herein should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The present invention described herein may be incorporated into any suitable vehicle, such as a car, a truck, a sport utility vehicle, a mini-van, a crossover, any other passenger vehicle, any suitable commercial vehicle, or any other suitable vehicle. Moreover, principles of the present disclosure may apply to other vehicles, such as planes, boats, trains, drones, or other suitable vehicles. Moreover, the present invention may be incorporated into various steering system schemes and electric power steering (EPS) systems, including steer-by-wire systems.

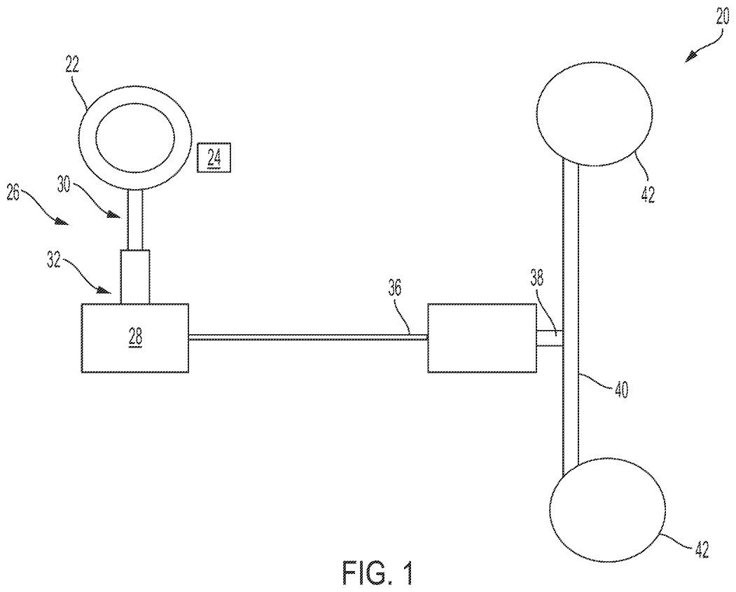

Referring initially to FIG. 1, a power steering system 20 is generally illustrated. The power steering system 20 may be configured as a driver interface steering system, an autonomous driving system, or a system that allows for both driver interface and autonomous or semi-autonomous steering. The steering system may include an input device 22, such as a steering wheel or other HWAs, wherein a driver may mechanically provide a steering input by turning the steering wheel. An airbag device 24 may be located on or near the input device 22. A steering column 26 extends along an axis from the input device 22 to an output assembly 28. The steering column 26 may include at least two axially adjustable parts, for example, a first portion 30 and a second portion 32 that are axially adjustable with respect to one another. The output assembly 28 may include a pinion shaft assembly, an I-shaft, a cardan joint, steer-by-wire components or any other features conventionally located opposite the input device 22. In other words, the steering column 26 may include a mechanical connection to the steering linkage (also referred to as a rack) or may be a steer-by-wire system that does not require a continuous mechanical connection. The output assembly 28 may connect to a power-assist assembly 34 via a connection 36. The connection 36 may be one of a steering gear input shaft, a continuation of the pinion shaft assembly, or wired or wireless digital communication protocols.

The power-assist assembly 34 may operably connect to a steering linkage 40 via a steering gear assembly. In operation, actuation of the driver input 22 causes a responsive movement of the power-assist assembly 34 and causes the steering linkage 40 to steer an associated vehicle.

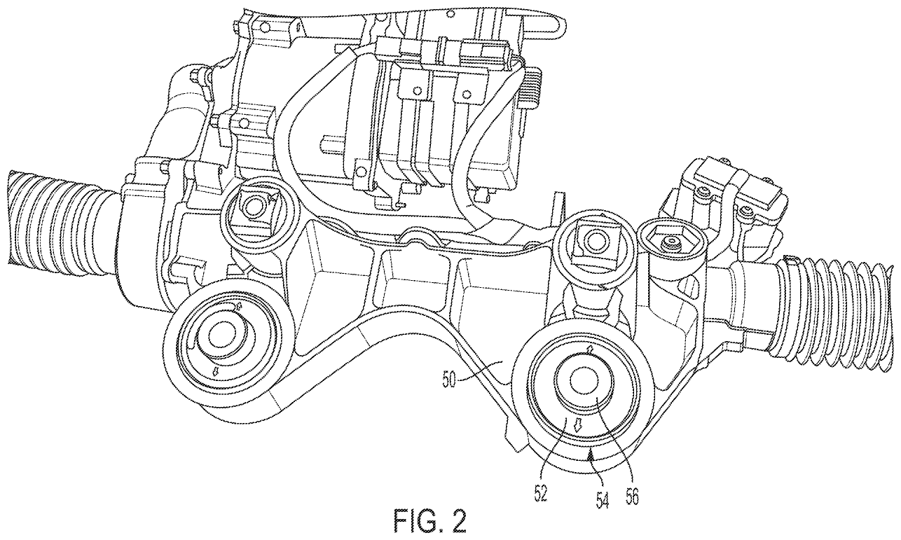

Referring to FIG. 2, a housing 50 of a rack assembly 26 is shown. The housing 50 has a mounting bushing 52 inserted within a recess or aperture 54 of the housing 50. The mounting bushing 52 interacts with a frame (not shown) in a fully assembled condition. Specifically, a bushing surface 56 is in contact with a frame surface.

To avoid relative movement between the steering gear and the frame 50, an otherwise smooth surface 56 of a mounting bushing 52 is texturized. In particular, the surface 56 of the mounting bushing that is texturized is a surface that interacts with the steering gear in the assembled condition. The term texturized refers to a roughening of the mounting bushing surface 56 to increase the coefficient of friction on the surface 56. Therefore, the surface 56 may also be referred to herein as a friction surface. Texturing of the mounting bushing surface increases the friction coefficient significantly. This increase provides sufficient friction to eliminate movement between the steering gear and the frame 50.

Although described above and illustrated as having the surface 56 of the mounting bushing 52 being texturized, it is contemplated that the frame surface is texturized instead of the surface 56 of the mounting bushing 52.

In some embodiments, the selection of the surface of the component that is texturized to increase friction is dependent upon a hardness property of the material. Specifically, in some embodiments, the component with the harder material property has the surface that is to be texturized. For example, in one embodiment the frame is formed of a first material having a first hardness, and the mounting bushing 52 is formed of a second material having a second hardness that is greater than the first hardness, such that the surface 56 of the mounting bushing is the surface that is texturized. By way of another example, the frame is formed of a first material having a first hardness, and the mounting bushing 52 is formed of a second material having a second hardness that is less than the first hardness, such that the frame surface is the surface that is texturized.

Although the embodiments disclosed herein specify an example of a steering system, it is to be appreciated that other types of assemblies could slip relative to a mounting surface and the texturing disclosed herein results in reduced slippage. Accordingly, the texturized surface assembly disclosed herein may more generally benefit a friction assembly for mounted components. In such embodiments, a first component as a first interface surface, a second component has a second interface surface, and the first interface surface and the second interface surface are in contact in an assembled condition. One of the first interface surface and the second interface surface are textured to form a friction surface. In some embodiments, the surface to be texturized is on the component with a greater hardness material property.

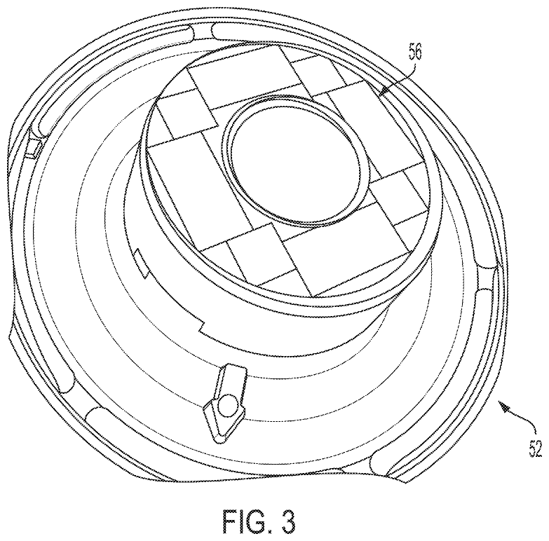

The surface texturizing disclosed herein may be done with various contemplated processes. In one embodiment, the texturizing is achieved with laser texturing. For example, laser etching may be utilized to texturize the surface. An example of the textured surface on the mounting bushing 52 is shown more clearly in FIG. 3.

The assemblies disclosed herein also provide a method of manufacturing an interfacing component assembly. The method includes comparing a first hardness of a first material of a first component to a second hardness of a second material of a second component, then determining which of the first material and the second material is a harder material. Texturing the harder material to form a friction surface with a laser is performed, and the first component and the second component are placed together with the friction surface being an interface between the first component and the second component. As discussed herein, the texturizing may be done with a laser process, such as etching.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description

What is claimed is:

1. A friction assembly for mounted components comprising:
a first component having a first interface surface; and
a second component having a second interface surface, wherein the first interface surface and the second interface surface are in contact in an assembled condition,
wherein one of the first interface surface and the second interface surface are textured to form a friction surface.

2. The friction assembly of claim 1, wherein the one of the first interface surface and the second interface surface is textured with a laser.

3. The friction assembly of claim 2, wherein the one of the first interface surface and the second interface surface is laser etched to form the friction surface.

4. The friction assembly of claim 1, wherein the first component is formed of a first material having a first hardness, wherein the second component is formed of a second material having a second hardness that is greater than the first hardness, and wherein the one of the first interface surface and the second interface surface which is etched is the second interface surface.

5. The friction assembly of claim 1, wherein the first component and the second component are assembled to each other in a vehicle.

6. The friction assembly of claim 5, wherein the first component and the second component are assembled to each other in a steering system.

7. A steering system comprising:
a steering gear;
a frame having a frame surface; and
a bushing having a bushing surface in operative contact with the frame surface and the steering gear, wherein the bushing surface is textured to form a friction surface.

8. The steering system of claim 7, wherein the one of the frame surface and the bushing surface is textured with a laser.

9. The steering system of claim 8, wherein the one of the frame surface and the bushing surface is laser etched to form the friction surface.

10. The steering system of claim 7, wherein the frame is formed of a first material having a first hardness, wherein the bushing is formed of a second material having a second hardness that is greater than the first hardness, and wherein the one of the frame surface and the bushing surface which is textured is the bushing surface.

11. The steering system of claim 7, wherein the frame is formed of a first material having a first hardness, wherein the bushing is formed of a second material having a second hardness that is less than the first hardness, and wherein the one of the frame surface and the bushing surface which is textured is the frame surface.

12. A method of manufacturing an interfacing component assembly comprising:
comparing a first hardness of a first material of a first component to a second hardness of a second material of a second component;
determining which of the first material and the second material is a harder material;
texturing the harder material to form a friction surface with a laser; and
placing the first component and the second component together with the friction surface being an interface between the first component and the second component.

13. The method of claim 12, wherein texturing the harder material with a laser comprising a laser etching process.
